(19) United States
(12) Patent Application Publication
(10) Pub. No.: US 2014/0278378 A1
(43) Pub. Date: Sep. 18, 2014

(54) CONTENT TO TEST CONVERTER SYSTEM (CTTCS)

(71) Applicant: Joe Mellett, Cincinnati, OH (US)

(72) Inventor: Joe Mellett, Cincinnati, OH (US)

(21) Appl. No.: 14/217,297

(22) Filed: Mar. 17, 2014

Related U.S. Application Data
(60) Provisional application No. 61/799,787, filed on Mar. 15, 2013.

(51) Int. Cl. G06F 17/27

(52) U.S. Cl. CPC G06F 17/2785
USPC 704/9

(57) ABSTRACT

This disclosure is drawn to methods, systems, devices and/or apparatus related to converting content to questions and/or tests. Specifically, the disclosed methods, systems, devices and/or apparatus relate to converting the content (e.g., website, text, audio, video) into one or more tests to test an audience's understanding of the content. Generally, the present disclosure includes converting any content such as a website, web page or other source material into a test. Example content may be remotely and locally stored content. In some examples, tests may be displayed via a third party hosted system website, directly on the website of the source material being converted, and/or in an application on the user's computing device.

### CROSS-REFERENCE TO RELATED APPLICATIONS

This application claims priority to U.S. Provisional Patent Application Ser. No. 61/799,787, filed on Mar. 15, 2013, the contents of which are incorporated herein by reference in their entirety.

### BACKGROUND

There is a need for measuring the level and specifics of understanding of information and content on the internet and in other media. Content owners, authors, and/or creators from industry, education or other areas may want to know but conventionally have no easy method to know which parts of their content people truly “get” and which ones they don't and by what degree. Measuring the world's knowledge and understanding may also be desirable.”

Furthermore, creating tests to test an audience's comprehension of content conventionally takes a lot of time and effort. With the internet being the largest repository of information, websites are a comprehensive, fast, and inexpensive starting point for the creation of such tests.

### BRIEF DESCRIPTION OF THE DRAWINGS

The foregoing and other features of the present disclosure will become more fully apparent from the following description and claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 is a schematic representation of a computing environment in which an example CTTCS may operate;

FIG. 2 is a flowchart depicting an example content to test conversion method;

FIG. 3 is a flowchart depicting another example content to test conversion method;

FIG. 4 depicts a flowchart showing an example workflow of an example content to test converter system;

FIGS. 5 and 6 depict a flowchart showing another example workflow of an example content to test converter system in which the content is web content;

FIG. 7 is a screenshot of a CTTCS host system website where a user may enter URL(s) of websites to be converted;

FIG. 8 is a screenshot of a source website with no CTTCS system enhancements;

FIG. 9 is a screenshot of an example test from an example website with an embedded test style test converter system;

FIG. 10 is a screenshot of another example test from an example website with a popup overlay style of the test converter system;

FIG. 11 a screenshot of another example website associated with an example website to test converter system;

FIG. 12 depicts a process for generating an example test in an example content to test converter system;

FIG. 13 is an example environment in which an example website to test converter system may be implemented, each in accordance with at least one embodiment of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and make part of this disclosure.

This disclosure is drawn to methods, systems, devices and/or apparatus related to converting content to questions and/or tests. Specifically, the disclosed methods, systems, devices and/or apparatus relate to converting the content (e.g., website, text, audio, video) into one or more tests to test an audience's understanding of the content.

Generally, the present disclosure includes converting any content such as a website, web page or other source material into a test. Example content may be remotely and locally stored content. In some examples, tests may be displayed via a third party hosted system website, directly on the website of the source material being converted, and/or in an application on the user's computing device.

In general, content to test converter systems (CTTCS) may provide converting content to tests and/or test items. The largest body of knowledge is on the Internet, so applications of CTTCS on the Internet may be desirable, but other applications also exist and will be described herein. In the present disclosure, CTTCS may refer to methods, systems, devices and/or apparatuses, websites, portals, applications, software, services, and/or host systems associated with converting content to a test.

FIG. 1 is a schematic representation of a computing environment 100 in which an example CTTCS 110 may operate, according to at least some examples of the present disclosure. The computing environment 100 may allow a computing device 120 to interact with the CTTCS 100 and a server 130 such as a web server. These may be connected in a communication network 190 such as the Internet, an intranet, and/or a local or remote network. Server 130 may include content 140, which may be accessible upon request from a device such as CTTCS 110 and computing device 120.

CTTCS 110 may include a conversion engine 111, rule set(s) 112, database(s) 113, a question generation engine 114, an output engine 115, and a scoring example 116. The conversion engine 111 may parse text content into words based on rules 112. The words may then be stored in the database(s) 113. The question generation engine 113 may use rules 112 to generate question(s) that include a portion of the words and to generate answer(s), answer choice(s), and/or explanation(s) for the questions. The questions relate to the content. The CTTCS 110 may retrieve verification content 180 from a third party source to verify the accuracy of content 140 before, during, or after generating the questions. Once generated, the questions may be output via the output engine 115 and transmitted to the computing device 120.

The output engine 115 may generate computer-readable code for displaying the questions in the computing device's 120 via a browser 121 or an application 122. In this manner, a user of computing device 120 may view the questions in the browser 121 and/or application 122 and respond to the questions. Responses to the questions may be transmitted back to the CTTCS 110 where the scoring engine 116 may determine if the user's responses are correct responses.

FIG. 2 is a flowchart depicting an example content to test conversion method 200, according to at least some examples of the present disclosure. The CTTCS may obtain 210 content from a source. The content may then be converted 220 to content parts based on conversion rule(s). The content parts may be stored 230 in database(s). The content parts may then be used to generate 240 questions based on generation rule(s). The generated questions may then be outputted 250.

Some example content sources may include a web page, a website, a document, a file, an image, a photograph, audio, video, a text message, an instant message, a map, a webinar, and/or a tutorial, for example. These sources may contain content that may be converted to questions. Example content may include digital content, text content, audible content, and/or visual content, for example.

In some examples, the content may be obtained 210 from a source (such as a website) in various ways. For example, the CTTCS may receive a file containing the content, the content may be copied from the source directly, the content may be derived from the source, and/or the content may be converted from one format to another format. In some examples, CTTCS may “screen scrape” content from the source, may derive the content from source code of the website, or may utilize a peer-to-peer network to obtain content. In some examples, audio or video content may be recorded and/or converted into a text format from which the CTTCS may use the content. This may require an audio-to-text converter and/or translation converter.

In some examples content for a test may be obtained from multiple media sources, for example video media, text on a webpage, and audio media.

When converting 220 the content into content parts according to conversion rules, the CTTCS may perform several operations, including analyzing the content, deconstructing the content, parsing the content, characterizing the content or content parts, categorizing the content or content parts, converting the content parts into another format, for example. In some examples, artificial intelligence modules and/or engines and/or neural networks may be incorporated to create and/or implement the conversion rules. In some examples, the user and/or test creator/publisher may create or choose conversion rules.

Some example content parts may include a document, a page, a web page, a section, a subsection, a paragraph, a sentence, a clause, a part of speech, a word, a character, a metatag, and metadata, for example.

In some examples, meta data, meta tags, and other tags in the html may be used to help the CTTCS identify, classify, and organize ideas and facts for generating questions, answers, or explanations.

Generating 240 questions, answers, answer choices, and/or explanations for the questions may occur in accordance with generation rules. Some example generation rules may include altering content parts, substituting content parts, reordering or rearranging the content parts, combining content parts with synonyms, antonyms, and/or other words, and combining content parts to form phrases and sentences. In some examples, the generation rules may include converting a declarative sentence to an interrogative sentence. In some examples, artificial intelligence modules and/or engines and/or neural networks may be incorporated to create and/or implement the generation rules. In some examples, the user and/or test creator/publisher may create or choose generation rules. In this manner, questions can be generated about the subject or topic of the content.

Generating answers may occur by using an answer algorithm from sources including, but not limited to the original source, the original source and other related sources, or only related sources.

Generating answers may also occur from user input. User input generated answers may occur by generation of questions based on the content or from a general questions bank. Then CTTCS may generate questions where only answer providers can add answers. Some answer providers may be human reviewers who review the questions and provide answers to the questions. Answers to the questions may be chosen, but are not limited to, a combination of the following ways: an answer voted on as best by most of the test takers answering the question, the answer voted on as best by the answer providers, or the answer voted on as the best by answer providers with a specified self-described skill level.

Some example questions may include an interrogative sentence, a yes-or-no question, a true-or-false question, a multiple choice question, a prioritization question, an ordering question, a mathematical question, a fill-in-the-blank question, an essay question, and/or an open-ended question, for example.

The questions may be outputted 250 in many ways. Some examples include generating documents, web pages, or audio filed containing the questions. In some examples, the questions may be published, displayed, and/or transmitted to a computing device. In this manner, a user may review and answer the questions.

After a user responds to questions, the responses may be transmitted to the CTTCS and compared with correct answers to determine if the user's responses are correct.

FIG. 3 is a flowchart depicting another example content to test conversion method, according to at least some examples of the present disclosure. The CTTCS may retrieve 310 text content from a web page, parse 320 the text content into words, analyze 330 characteristics of the words, and store 340 the words and characteristics in database(s). The CTTCS may then generate 350 questions, answers, and/or explanations about the text content using the words and characteristics thereof. These may be used to generate 360 a test, which may be generated 370 as computer-readable code for display on a computing device. In this manner, a user of the computing device may review the test and complete the test by responding to the questions.

The CTTCS may receive the user's responses and compare the received responses to correct answers. The user's responses may be stored in user databases, along with the questions and correct answers. These may be associated with a user account for the user. This may allow tracking of the user's progress and/or test activities.

In some examples, the CTTCS may retrieve verification content from a third party source to verify the accuracy of the text content. Such verification may include comparing the text content to the verification content. The verification may occur prior to, during, and/or after generating the questions. In some examples, a database of verified facts may be used to improve questions, answers, or explanations.

In some examples, generated questions may be stored for later use on other test. These questions may be stored in question database(s) that may be accessible for use on tests for the same user or other users.

FIG. 4 depicts a flowchart showing an example workflow 400 of an example content to test converter system, according to at least some examples of the present disclosure. A user may navigate a browser to a testing website such as tests.com. The testing website may have an input box allow the user to enter a target website (item 410). This target website will be the content on which the test will be based. For example, if the target website is www.irs.gov, the test may be focused on U.S. Internal Revenue Service and/or U.S. tax laws and regulations. The CTTCS may then navigate the target website and obtain or otherwise harvest the content from the target website (item 420). In some examples, the CTTCS may search third party sources such as the Internet for content that is similar to the content on the target website (item 430). With the target website content (and third party content in some examples) obtained, the content may be parsed into content parts, which may be assembled into questions and answers (item 440). This parsing and assembling may utilize artificial intelligence methods and/or systems. Parsing content and assembling questions may include analyzing and deconstructing microdata, HyperText Markup Language (HTML) code, Extensible Markup Language (XML) code. This may also include breaking down paragraph and/or sentence structure of the content. The CTTCS may also examine the content from the target website and compare it to the third party content to determine accuracy, “trustability,” conflicts, and/or freshness of the target website content (item 450). The content parts, content, and/or third party content may then be stored in database(s) (item 460). The content parts, content, and/or third party content may then be read from the database(s) to generate a test for a topic related to the content of the target website. Test generation may also utilize artificial intelligence methods and/or systems.

FIGS. 5 and 6 depict a flowchart showing another example workflow 500 of an example content to test converter system, in accordance with at least some examples of the present disclosure. In some examples, CTTCS may implement the following example process:

CTTCS may read a sentence on a web page, then analyze and categorize 510 the sentence. This may include determining, analyzing, and tracking the following:
parts of the sentence (e.g., noun, subject, object, pronoun);
punctuation (e.g., commas, italics, periods, question marks);
display characteristics (e.g., bold, capitals, underlines);
length of words and sentences;
internet based elements (e.g., hyperlinks, radio buttons, check boxes);
words common to the art of testing including: question, answer, which, who, what, where, why, how, true, false, and the like; and/or
other elements useful in identifying, tracking, and analyzing the source material.

For example, depending on the context, a phrase in italics may help determine that it is a book and thus a question may be asked about that book from other references to the book on the internet and elsewhere.

CTTCS may then convert 520 the source material to a quiz, test, exam, poll or survey including questions, answers, explanations, and the like. For example, the source material on a certain web page might state “Ben Franklin was born on Milk street in Boston, Mass. on Jun. 6, 1700, which was a nice day.” This statement could be converted to a question such as: “Ben Franklin was born on Milk street in Boston, Mass. on ______ which was a nice day.” The blank portion may display a pull-down menu with 4 dates, only one of which is Ben Franklin's correct birthday.

CTTCS may vary, re-arrange, and/or modify 530 the converted test. In some examples, CTTCS may utilize synonyms, antonyms, abbreviations, acronyms, and/or other methods to improve and/or vary the converted test from its original form while still preserving the facts, ideas, and understanding of the source material. For example “Ben Franklin was born on Milk street in Boston, Mass. on Jun. 6, 1700, which was a nice day.” may be varied to state: “Ben Franklin was born on Milk St. in Boston, Mass. on Jun. 6, 1750 which was a good day.” (Underlining was added for illustrative purposes).

CTTCS may utilize 540 existing questions, answers, explanations, and other test and forum elements from the Internet to convert and/or vary per the above description.

CTTCS may validate, review, and/or rate 550 the quality of the converted test by comparing other website references and test elements of the same facts, ideas, and material to the converted test.

CTTCS may automatically edit the converted test by checking grammar, punctuation, spelling, and sentence structure.

CTTCS may improve the converted test by allowing for human input 560 in the form of ratings, rankings, reviews, editing, and additions to the test by the public and/or users with permission.

CTTCS may save and track 570 all test history, activity and statistics about the testing and testing environment in one or more database on the hosted system. In some examples, CTTCS may save the converted test itself to the hosted system and/or run the algorithm “on the fly” each time the web page or test is accessed. This data may be used to improve the converted tests over time. For example, CTTCS may:
track the answer through rate (ATR) which is the percentage of time people are presented with a question and then answer it;
track time spent on each test;
track % correct and incorrect; and/or
track the number of answer changes.

This information may be valuable feedback so that the tests keep improving over time.

CTTCS may generate more questions than a test taker may see such that a validity/reliability/fairness (VRF) score may be generated for each question and the higher the score, the more often that question is shown. Questions that have a low VRF score may be phased out.

In this manner, a standardized, comparable set of questions can be compared from test taker to test taker. VRF-approved question sets may be shown to users except during pilot tests of random non-VRF approved question sets of random questions meant to improve test quality.

In some examples a publisher may lock a test in order to prevent the CTTCS from automatically improving the test.

CTTCS may display options to download a tool bar and/or other plugin for a more integrated and improved testing experience.

In some examples, a test publisher or user may create conversion and/or generation rules based on a unique layout and technology on a web page or network of pages. For example, most wikipedia.com pages look the same, so rules for a wikipedia page may include:
Generate a test title:
   Read the HTML title of ‘Benjamin Franklin—Wikipedia, the free encyclopedia’ into a field called ‘source html title’.
   Remove ‘—Wikipedia, the free encyclopedia’ as this is common with all wiki pages
   Append ‘ Test’ to what is left leaving a title for the test which says “Benjamin Franklin Test”
   Store the title in the ‘test title’ field for this test in a database
Generate the main ideas of the test:
   Read the body text that is above the ‘contents’ table and below the indented text which follows “From Wikipedia, the free encyclopedia” into a field called ‘main source ideas”
   Copy the ‘main ideas source’ field to the ‘main ideas test’ field and strip out extraneous content like formatting.
   This field can be used for questions like ‘what are the main ideas in the source document’ then compare what the test taker types to words in the source field to see what percent match and in what order.
Generate sections of the test:
   Each item in the ‘Contents’ table is identified and put into fields representing sections and subsections of the test.
Use images:
   The system reads in ben franklin's first wiki page image and the title of it above the image
   A question is generated for the test taker such as ‘True or False, is this a picture of Ben Franklin?
Generate questions, answers and explanations:
   Check settings for the number of questions for this document, and if none are specified generate X number of questions where X=(# of sentences* 2)+(# of paragraphs)+(the # of words/100) except where there are less than 5 sentences in which case X=1.
   Go to each sentence one at a time and generate multiple choice questions in the form a question with 5 answer choices.
Validate source material
   Use the ‘external links’ section to compare the source facts with other sources.
   Crawl the general internet for other content about Ben Franklin and compare and record data on those sources versus the original wiki source such as, but not limited to:
      Keyword percentage matching.
      The number of characters in total and as a percentage that exist as exact strings between the two documents.
      Whether the arrangement between the two documents are the same.
      Whether the facts on the two documents correspond.

In some examples, CTTCS may make use of questions and answers which measure deeper understanding. For example, CTTCS may present the user with a source paragraph from the content for x amount of time. CTTCS may then ask the user to write as much as they can about the content they just read. The system may then generate a quality score based on factors, for example:
the % of words that match between the source and what the test taker wrote
the sum of all the words in strings of 2 or more words
how many key words (all words minus words like the, and, of, etc.)

In some examples, CTTCS may generate question such as “What is the main idea of the first paragraph?” The test taker may the write the answer into a text box. The system may display or send the question and answer to other users within the system for them to vote on if the answer is correct.

The CTTCS may include a setting where every correct and incorrect answer has the applicable source information highlighted or otherwise noted and relevant external links may be provided for additional information.

In some examples, the CTTCS may include an explanation or rationale generator from which an explanation of correct and incorrect answers may be generated and stored in the question database, for example. For example, if the question was ‘Ben Franklin was born in [1706]?’ whereby what is in brackets is a fill in the blank, then an explanation may include the exact source sentence or paragraph that the question was generated from.

FIG. 12 depicts a process 1200 for generating an example test in an example content to test converter system, according to at least some examples of the present disclosure. The CTTCS may allow a user to keyword search or otherwise select the content and/or source for a test. The CTTCS may then allow the user to select at least a portion of the content and/or source to generate the test. The user may enter certain test parameters as described herein and he may then instruct the CTTCS to generate the test based on the content, source, and/or test parameters. The example test of FIG. 12 includes a basic 3-question test.

Some example test parameters may include:
Content on web page or related content on the web or local computer?
Web links used?
Convert just excerpts of content or the full text?
Number of questions
Difficulty
Include survey?
Colors, images?
Public/private?

In some examples, example test questions may be in one or more formats, including the following examples:
True or False, such as “True or False, did the web page state X?”
Multiple choice;
Timed or untimed;
Prioritization, ordering, and/or ranking;
Fill in the blank;
“Did the web page state X or Y?”
Open-ended questions, such as “What subject matter did the web page discuss the most? (These questions may capture keywords in an answer and compare them to keywords on the web page.);
Generate facts from the web page text and rank them in order of appearance, and/or remove duplicates; and/or
“What year was X born?”
What was the tone or feeling of the content?
What is your opinion of the content?

In some examples, a test may be displayed in one or more formats including a popup box on top of the web page being converted (see, for example, FIG. 10), embedded into the content of the web page itself (e.g., above, below, or within the web pages' content) (see, for example, FIGS. 9 and 11), the web page itself whereby the page's original form is modified (see, for example, FIG. 9), and/or as a separate document/URL, among others. In some examples, tests results may be evidence that a web page has been read and understood.

In some examples, a test may be displayed or delivered in a variety of ways, including within advertisements, email, messages/chats, audio, and/or video.

In some examples, web pages and/or tests related to the subject matter of the source web page may be displayed when a user hovers an input device (e.g., mouse, finger) over a test question. Similarly, related web pages and/or tests may be displayed on popup and/or at the bottom.

In some examples, a user may obtain a converted test in several ways including, for example,
By visiting a site with CTTCS operating or installed on it, whereby the user may type in the URL(s) of websites and/or web pages to be converted. FIG. 7 depicts an example of this.
By visiting websites and web pages that have already been set up to be converted via a link on the page to do it, a tool bar that has been installed and/or some other widget set up on that site. FIGS. 8-10 depict examples of this.

It should be noted that there is no permanent change to a website once it is converted, but rather the change is merely in how a user views it.

In some examples, CTTCS may identify question marks on web pages to identify possible questions. In some examples, CTTCS may adapts tests based on the number of people taking the test. For example, if a particular question is receiving a lot of incorrect answers, the question may be poorly converted and it may be reworded.

In some examples, CTTCS may look at other web pages or resources with the same or similar information to determine if the facts are being presented correctly. For example, if 95% or more of web pages say Ben Franklin's birthdate is X, then it is likely X.

In some examples, CTTCS may use one more sources that a user designates. For example, a user can request to create a test about Ben Franklin based on three sources with .edu domain names. The CTTCS could:
Scan the web for all .edu websites with content about Ben Franklin.
Choose the three websites to create questions based on the quality of the pages as determined by specified factors, including but not limited to: spelling mistakes, checks against the CTTCS database for known facts about Ben Franklin.
Generate, for example, a test, questions, answers, or explanations.

In some examples, CTTCS may combine or append questions into any converted page from other web page's tests and questions.

In some examples, access to CTTCS may be free and/or may include a paid access model. This may include a flat fee, a subscription, and/or a freemium model, among others. Other ways to generate revenue from CTTCS may include:
Ads overlayed in the test
Ads sent when people have their tests emailed to them
Link referral fees from a “directory of tests”
Test takers pay upgrade fee to have more stats, features, and/or reports
Publishers pay for upgraded features
Government pays for test and results data
Employers pay to find candidates that score high
Test takers pay to share their scores with employers
Test takers pay to take tests and publishers get a portion

Some example users may include a person who converts web pages to a test, a person who reads the original web page and wants to take a test, and/or a person who did not read the original page and wants to take (or was assigned) the test.

Some example users may use the CTTCS to take tests in order to help them remember more material they have read.

Some example users may use the CTTCS to take tests in order to obtain credentials, for example a certificate of completion for learning specific materials.

In some examples, a user may utilize software and/or and application and input in a URL of a website or webpage to be converted to a test. In some examples, a user may navigate to a website that already has been converted to a test. In some examples, user may review and agree to terms of service. In some examples, a user may then define a method to convert the source material to a test. In some examples, a user may define the type of test it gets converted to, including, for example, time/no time, language, and/or keyword filters.

In some examples, questions may be created from the ads on a webpage URL that a user typed or is on as opposed to the content of the webpage itself. In some examples, questions may be created from audio files on a webpage URL that a user typed or is on. In some examples, clicking or hovering over a sentence, word, or paragraph on a webpage may convert it to the basis of a sentence, related links, a question, or answer. In some examples, question may be created from an online message or chat program. In some examples, questions may be created from movies online. In some examples, questions may be created from an online webinar.

In some examples questions may be created from existing questions on the Internet. For example, a user may request the CTTCS to create a test from existing questions and answers on the internet.

In some examples questions may be created based on media a user provides.

In some examples, questions may be created based on a subject matter that a user provides. The CTTCS may search the Internet for sources related to the subject matter and may create questions from the related sources.

Websites may have an incentive to use CTTCS on their websites because it may assist with engaging users, understanding user comprehension of the source material on the website, generating ideas from the user community, and the like. An example for assisting with engaging users includes but is not limited to a test in which a user has to pass in order to gain additional access to the site.

In some examples, web pages that badly convey information may be tested multiple times. CTTCS may generate automatic suggestions of how to improve the web site, such as adding additional content, and identifying particular issues that users are not understanding, for example.

CTTCS may have many applications. For example, a company or school may display their information on their website and they may want to test job applicants or students without creating tests by hand. In another example, CTTCS may provide a way to gauge the understanding of what people are trying to communicate on the entire Internet by having questions about the web page show below the web page. CTTCS may also provide a way to make tests or the structure/template of a test for later modification. Another example may be that a user inputs in a Wikipedia.com page and the Wikipedia.com page becomes a test (this may or may not require a partnership with Wikipedia.com). In another example, CTTCS may provide a world wide web knowledge contest with questions on pages all over the Internet. Other applications may be to reinforce what a user learned, or to assist Alzheimer's patients with memory recall.

Some example applications may include:
Academic, classrooms, study, test preparation
   Help guide the content delivery for learning because questions will lead to the right info being presented
   Provide test session proctoring online using computer camcorders
   Users or publishers may designate a certain score for a test and the users keep taking the test until the score is achieved.
Commercial
   Business, internal, departments, customers
Customer Service—a text transcript may be created from voice customer service and a test may be created:
   For the customer to see if they understood the communication, liked the service, etc.
   For the agent to see if they understood the communication of the customer
Hiring
   Test new candidates and hire the best test takers
   Employers can search database of anyone who scored well on any type of test
Research
Marketing research
   Get demographic data on who ‘gets’ their product, where they live, age, etc. Some of the info maybe used to qualify test takers
   Test takers may enter their age, sex, interests, skill level, etc.
   Get domain information from internet protocol number, for example location, time when test was taken, etc.
Contests
Education—traditional and online
Motivation/Team Building
Shopping
Testing—a way to create tests on the fly from anywhere, quickly and cheaply
“Was this page useful?” feedback

Using psychometric standards and the data from testing, tests may be improved yet because of sample size restrictions this process is often slower than it has to be. A system which automatically tests all available Internet content may generate more testing data faster. Which test questions test takers encounter is conventionally a subjective matter with questions being chosen by individuals instead of algorithms. Using algorithms to create questions combined with applying psychometric standards and analyzing aggregate test taking data provide for better quality questions and answers (e.g., remove questions that too many people get wrong).

Conventionally, new ideas and content have to be around for a while for tests to be developed around them instead of having an assessment available at the point of new content creation.

The owner of a website may use the data associated with CTTCS in a number of ways. For example,:
Data Analysis Reports, including
   Types of websites most tested;
   Average time spent per test;
   Number of tests per user IP address;
   Aggregate right, wrong, skipped;
   Preferences most defined (indicating which tests are most preferable); and/or
   Governments and think tanks may understand the world's knowledge.
Advertising
   Contextual advertising may be displayed;
   Place Google® ads or other ads into the tests (even if the source material website doesn't have ads); and/or
   Receive data on advertising.
Services
   Charge companies for options on their web pages;
      Can it be tested;
      Upgrade type tests and share the data with them about the testing—or let companies always have the data on their web pages being tested.
Education/Homeschooling
   Allow any website to be tested including university websites and/or application websites like blackboard.

In some examples, the test may be converted and/or taken using CTTCS on any computing device, including a desktop computer, laptop computer, tablet, a credit card terminal, a cash register, a cellular phone, and/or a smartphone, for example. The users may use their devices to convert the website to a test, and take the test through an input device, by voice instruction, by entering text, and/or by entering numbers.

In some examples, users can post their test scores automatically to social media sites.

In some examples, a “study mode” option may provide an instant “incorrect, please choose another answer” prompt for incorrect answers. This mode may also provide explanations for correct answers.

In some examples, scores, other test data, or user actions may trigger the CTTCS to actions that include, but are not limited to:
Auto saving of test progress
The posting of scores on a webpage
Showing of specific ads
Updating contest progress, for example “who can answer the most items correctly this week?”
Give awards depending on a publishers assigned values to individual questions answered correctly or to specific test scores

In some examples, artificial intelligence may be incorporated to further adapt the tests. In some examples, CTTCS may track test preferences, metrics, and/or statistics of a user. Example which may include a study mode, timer, preferences, and/or test history. In some examples, CTTCS may include a fresh meter, which may display how recently a test was updated. In some examples, “wiki”-like editors may be provided to revise tests. In some examples, CTTCS may include one or more language translation add-on such that the add-on would be a text-to-test translator. In some examples, CTTCS may include a distractibility detector, in which a user must make some keystroke on the screen every X seconds or they are deemed to be distracted.

FIG. 13 illustrates an exemplary environment 1600 for implementing and/or controlling various aspects of an example system that includes a computing device such as computer 1602, the computer 1602 including a processing unit 1604, a system memory 1606 and a system bus 1608. The system bus 1608 couples system components including, but not limited to, the system memory 1606 to the processing unit 1604. The processing unit 1604 may be any of various commercially available processors. Dual microprocessors and other multi-processor architectures may also be employed as the processing unit 1604.

The system bus 1608 may be any of several types of bus structure that may further interconnect to a memory bus (with or without a memory controller), a peripheral bus, and a local bus using any of a variety of commercially available bus architectures. The system memory 1606 includes read only memory (ROM) 1610 and random access memory (RAM) 1612. A basic input/output system (BIOS) is stored in a non-volatile memory 1610 such as ROM, EPROM, EEPROM, which BIOS contains the basic routines that help to transfer information between elements within the computer 1602, such as during start-up. The RAM 1612 may also include a high-speed RAM such as static RAM for caching data.

The computer 1602 may further include an internal hard disk drive (HDD) 1614 (e.g., EIDE, SATA), which internal hard disk drive 1614 may also be configured for external use in a suitable chassis (not shown), a magnetic floppy disk drive (FDD) 1616, (e.g., to read from or write to a removable diskette 1618) and an optical disk drive 1620, (e.g., reading a CD-ROM disk 1622 or, to read from or write to other high capacity optical media such as the DVD). The hard disk drive 1614, magnetic disk drive 1616 and optical disk drive 1620 may be connected to the system bus 1608 by a hard disk drive interface 1624, a magnetic disk drive interface 1626 and an optical drive interface 1628, respectively. The interface 1624 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 1602, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of an example system.

A number of program modules may be stored in the drives and RAM 1612, including an operating system 1630, one or more application programs 1632, other program modules 1634 (e.g., conversion engine, question generation engine, output engine, scoring engine) and program data 1636 (e.g., content, questions, and/or tests). All or portions of the operating system, applications, modules, and/or data may also be cached in the RAM 1612. It is appreciated that an example system may be implemented with various commercially available operating systems or combinations of operating systems. In some examples, example systems and methods may include and/or operate on a non-transitory computer-readable medium.

A user may enter commands and information into the computer 1602 through one or more wired/wireless input devices, e.g., a keyboard 1638 and a pointing device, such as a mouse 1640. Other input devices (not shown) may include a microphone, an IR remote control, a joystick, a game pad, a stylus pen, touch screen, or the like. These and other input devices are often connected to the processing unit 1604 through an input device interface 1642 that is coupled to the system bus 1608, but may be connected by other interfaces, such as a parallel port, an IEEE 1394 serial port, a game port, a USB port, an IR interface, etc.

A monitor 1644 or other type of display device is also connected to the system bus 1608 via an interface, such as a video adapter 1646. In addition to the monitor 1644, a computer typically includes other peripheral output devices (not shown), such as speakers, printers, etc.

The computer 1602 may operate in a networked environment using logical connections via wired and/or wireless communications to one or more remote computers, such as a remote computer(s) 1648. The remote computer(s) 1648 may be a workstation, a server computer, a router, a personal computer, portable computer, microprocessor-based entertainment appliance, a peer device or other common network node, and typically includes many or all of the elements described relative to the computer 1602, although, for purposes of brevity, only a memory storage device 1650 is illustrated. The logical connections depicted include wired/wireless connectivity to a local area network (LAN) 1652 and/or larger networks, e.g., a wide area network (WAN) 1654. Such LAN and WAN networking environments are commonplace in offices, and companies, and facilitate enterprise-wide computer networks, such as intranets, all of which may connect to a global communication network, e.g., the Internet.

When used in a LAN networking environment, the computer 1602 is connected to the local network 1652 through a wired and/or wireless communication network interface or adapter 1656. The adaptor 1656 may facilitate wired or wireless communication to the LAN 1652, which may also include a wireless access point disposed thereon for communicating with the wireless adaptor 1656.

When used in a WAN networking environment, the computer 1602 may include a modem 1658, or is connected to a communications server on the WAN 1654, or has other means for establishing communications over the WAN 1654, such as by way of the Internet. The modem 1658, which may be internal or external and a wired or wireless device, is connected to the system bus 1608 via the serial port interface 1642. In a networked environment, program modules depicted relative to the computer 1602, or portions thereof, may be stored in the remote memory/storage device 1650. It will be appreciated that the network connections shown are exemplary and other means of establishing a communications link between the computers may be used.

The computer 1602 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth wireless technologies. Thus, the communication may be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, etc.) to provide secure, reliable, fast wireless connectivity. A Wi-Fi network may be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks may provide real-world performance similar to the basic 10 BaseT wired Ethernet networks used in many offices.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method, comprising:
obtaining content from a source;
converting the content into a plurality of content parts based, at least in part, on one or more conversion rule;
storing the plurality of content parts in one or more database;
generating a question from at least a portion of the plurality of content parts based, at least in part, on one or more generation rule; and
outputting the question.

2. The method of claim 1, wherein obtaining the content from the source comprises at least one of:
receiving a file including the content;
copying the content from the source;
deriving the content from the source; and
converting the content from the source into a format different than the content.

3. The method of claim 1, wherein converting the content into a plurality of content parts based, at least in part, on one or more conversion rule comprises at least one of:
analyzing the content;
deconstructing the content into the plurality of content parts;
parsing the content into the plurality of content parts;
characterizing the content;
characterizing the plurality of content parts;
categorizing the content;
categorizing the plurality of content parts;
converting the plurality of content parts into a format different than the plurality of content parts; and
converting the plurality of content parts into a common format.

4. The method of claim 1, wherein generating the question from at least a portion of the plurality of content parts based, at least in part, on one or more generation rule comprises at least one of:
altering at least one content part of the plurality of content parts to create at least one altered content part;
substituting at least one content part of the plurality of content parts to create at least one substitute content part;
altering an order of the plurality of content parts;
combining at least a portion of the plurality of content part with at least one of a substitute content part, an alternative content part, an interrogative word, a synonymous word, and an antonymous word;
combining at least a portion of the plurality of content parts into a phrase; and
combining at least a portion of the plurality of content parts into a sentence.

5. The method of claim 1, wherein generating the question from at least a portion of the plurality of content parts based, at least in part, on one or more generation rule comprises converting a declarative sentence into an interrogative sentence.

6. The method of claim 1, wherein outputting the one or more question comprises at least one of:
generating a document including the one or more question;
generating a web page including the one or more question;
generating an audio file including the one or more question;
publishing the one or more question;
displaying the one or more question; and
transmitting the one or more question to a computing device.

7. The method of claim 1, further comprising:
receiving a response to at least one of the one or more question; and
determining if the response is a correct response to the one or more question.

8. The method of claim 1, wherein the source comprises at least one of a web page, a website, a document, a file, an image, a photograph, audio, video, and a tutorial.

9. The method of claim 1, wherein the content comprises at least one of digital content, text content, audible content, and visual content.

10. The method of claim 1, wherein the plurality of content parts comprises at least one of a document, a page, a web page, a section, a subsection, a paragraph, a sentence, a clause, a part of speech, a word, and a character.

11. The method of claim 1, wherein the question comprises at least one of an interrogative sentence, a yes-or-no question, a true-or-false question, a multiple choice question, a prioritization question, an ordering question, a mathematical question, a fill-in-the-blank question, an essay question, and an open-ended question.

12. A system, comprising:
a conversion engine configured to parse text content into a plurality of words;
at least one database in communication with the conversion engine, the at least one database configured to store the plurality of words;
a question generation engine in communication with the at least one database, the question generation engine configured to generate a question based, at least in part, on at least one generation rule, the question being based on the text content and including at least a portion of the plurality of words; and
an output engine in communication with the question generation engine, the output engine configured to output the question to a computing device.

13. The system of claim 12, further comprising a scoring engine configured to receive a response to the question, and further configured to determine if the response is a correct response to the question.

14. The system of claim 12, wherein the at least one generation rule comprises at least one of:
alter at least one word of the plurality of words;
substitute at least one word of the plurality of word;
alter an order of the plurality of words;
combine at least a portion of the plurality of words a substitute word;
combine at least a portion of the plurality of words into a phrase; and
combine at least a portion of the plurality of words into a sentence.

15. The system of claim 12,
wherein the question generation engine is further configured to generate a plurality of questions related to the text content; and
wherein the output engine is further configured to organize the plurality of questions into a test and further configured to transmit the test to a web server.

16. The system of claim 14, wherein the output engine is further configured to generate computer-readable code for the test such that the test may be displayed in a browser.

17. A method, comprising:
retrieving text content from a source web page;
parsing the text content into a plurality of words;
characterizing each of the plurality of words based on a characteristic of the plurality of words;
storing the plurality of words and the characteristics in one or more test databases;
generating a first question about the text content, the first question including at least a portion of the plurality of words and at least a portion of the characteristics;
generating a second question about the text content, the second question including at least a portion of the plurality of words and at least a portion of the characteristics;
generating a test including at least the first question and the second question; and
generating computer-readable code adapted to display the test on a computing device.

18. The method of claim 17, further comprising:
receiving a first response to the first question and receiving a second response to the second question;
comparing the first response to a first correct answer;
comparing the second response to a second correct answer; and
storing the first question, first response, the first correct answer, the second question, second response, and the second correct answer in one or more user databases; and
associating the first question, first response, the first correct answer, the second question, second response, and the second correct answer with a user that provided the first response and the second response.

19. The method of claim 17, further comprising:
retrieving verification content from a third party source, the verification content being associated with a subject of the text content;
verifying accuracy of the text content based on a comparison of the verification content to the text content; and
wherein generating the first question occurs after verifying the accuracy of the text content; and
wherein generating the second question occurs after verifying the accuracy of the text content.

20. The method of claim 17, further comprising:
storing the first question and the second question in one or more question databases;
retrieving at least one of the first question and the second question from the one or more question databases; and
generating a new test including at least one of the first question and the second question.
